(19) United States
(12) Patent Application Publication
(10) Pub. No.: US 2026/0163302 A1
(43) Pub. Date: Jun. 11, 2026

(54) ARRANGEMENT WITH CPA AND CONNECTOR ASSEMBLY

(71) Applicant: TE Connectivity Solutions GmbH, Schaffhausen (CH)

(72) Inventors: Konrad Helmut ROTH, Bensheim (DE); Christian WEBER, Bensheim (DE); Georg PUCKEL, Bensheim (DE)

(21) Appl. No.: 19/186,159

(22) Filed: Apr. 22, 2025

(30) Foreign Application Priority Data
Apr. 23, 2024 (DE) 102024111397.9

(51) Int. Cl. H01R 13/629; H01R 13/641

(52) U.S. Cl. CPC H01R 13/62933; H01R 13/641

(57) ABSTRACT

An arrangement for an electrical connector pluggable with a mating connector includes a housing, a lever attached to the housing movable between a pre-plugging disposition and a final plugging disposition, and a CPA movably attached to the lever movable from a delivery position through a ready-to-lock position to a locking position. The CPA secures the lever in the final plugging disposition to the housing when in the locking position. The lever is moved from the final plugging disposition to the pre-plugging disposition when the CPA is in the delivery position. The CPA is moved from the delivery position to the ready-to-lock position when the lever is in the pre-plugging disposition. The lever is moved to the final plugging disposition when the CPA is in the ready-to-lock position. The CPA is moved to the locking position when the lever is in the final plugging disposition and when the CPA is in the ready-to-lock position.

### CROSS REFERENCE TO RELATED APPLICATIONS

This application claims the benefit of DE Application No. 102024111397.9, filed 23 Apr. 2024, the subject matter of which is herein incorporated by reference in its entirety.

### BACKGROUND OF THE INVENTION

The subject matter herein relates to an arrangement for an electrical connector that can be plugged together with a mating connector including a connection position assurance device (CPA).

Electrical connectors are used for detachable plug connections for transmitting electrical currents and/or signals, for example, in the electromobility sector. For plug connections with a plurality of contacts, levers are typically used as a plugging aid to ensure that the plugged connectors are plugged in uniformly, quickly, and securely with little effort. A CPA is used to ensure that the plugged connectors are correctly positioned and to secure the connectors in the plugged state. The CPA should be easy to integrate into the assembly process of an arrangement and to operate during the plugging process. At the same time, the CPA should reliably secure the plugged connectors. There is a need for an electrical connector arrangement that meets these requirements.

### BRIEF DESCRIPTION OF THE INVENTION

In an embodiment, an arrangement for an electrical connector that can be plugged together with a mating connector is provided, with a housing, with a lever that is attached to the housing and that is movable between a pre-plugging disposition and a final plugging disposition, with a CPA that is movably attached to the lever and that is movable from a delivery position through a ready-to-lock position to a locking position, wherein the CPA secures the lever in the final plugging disposition to the housing when in the locking position, wherein the lever is movable from the final plugging disposition to the pre-plugging disposition when the CPA is disposed in the delivery position, wherein: the CPA is movable from the delivery position to the ready-to-lock position when the lever is in the pre-plugging disposition; and the lever is movable to the final plugging disposition when the CPA is in the ready-to-lock position; and the CPA is movable to the locking position when the lever is in the final plugging disposition and when the CPA is in the ready-to-lock position.

In another embodiment, a connector assembly is provided with an arrangement as described above and with a mating connector, wherein the connector and the mating connector can be plugged together when the lever is in the pre-plugging disposition and the connector and the mating connector are fully assembled when the lever is in the final plugging disposition.

These solutions allow for simple, faster, and reliable assembly of plug connections, which is particularly important for safety-critical applications, such as power supply, in particular for securing systems, in the electromobility sector. With these solutions, further processing of arrangements is made more efficient, the risk of assembly errors is reduced and maintenance of connectors with CPA is facilitated.

The subject matter herein can be further improved by the following configurations which are advantageous by themselves and which may be combined with one another at random.

The pre-plugging disposition of the lever differs from the final plugging disposition. In the pre-plugging disposition, the lever is pivoted opposite to the final plugging disposition, in particular towards the housing.

In an advantageous configuration, the lever attached to the housing is arranged such that it can be rotated or pivoted for intuitive operation, which increases efficiency and productivity during assembly.

Complete assembly of the connector with the mating connector denotes the completed and correct mating of the connector and the mating connector and therefore the intended establishment of a fully functional plug connection between the connector and the mating connector. The contacts and/or terminals disposed in the connector are correctly connected to the complementary contacts and/or terminals of the mating connector during the complete assembly and establish an electrical connection.

The arrangement can be moved to a delivery state, a ready state, and an assembled state.

In the delivery state, the lever can be in the final plugging disposition and the CPA can be disposed in the delivery position. In the ready state, the lever can be in the pre-plugging disposition and the CPA can be disposed in the ready-to-lock position, and in the assembled state, the lever can be in the final plugging disposition and the CPA can be disposed in the locking position.

In the delivery state, the arrangement can be further processed, in particular be preassembled, for example, by inserting contacts, terminals, and/or connecting the arrangement to electrical cables such as a cable harness. After preassembly, the arrangement can be put into the ready state to indicate that it is ready for assembly. After the connector of the arrangement has been plugged with the mating connector, the arrangement can be disposed in the assembled state and indicate a correct assembly state, i.e. complete assembly or final assembly.

The lever can comprise two parallel legs and a web connecting the two legs to each other, where the CPA can be arranged at the web. The lever can be configured to be U-shaped for a natural gripping position. This shape increases stability, as the lever is less likely to break and is not as easily bent. The web can serve as a handle.

In addition to the lever's function as a plugging aid for transmitting a uniform plugging force in the event of several pins, contacts, or terminals, the lever can additionally be used for drawing the mating connector towards the connector. For this purpose, the lever can be connected to one or more gears that are driven by it. The at least one gear can be located in particular at the end of one or both legs facing away from the web.

In order to utilize the available installation space, the CPA can be inserted into the lever, in particular into the web of the lever. In the lever or in a receptacle of the lever, the CPA can advantageously be moved in a straight line. Particularly, the CPA can be guided translationally in the direction of displacement of the CPA within the lever. The movement of the CPA from the ready-to-lock position to the locking position and the movement of the lever from the pre-plugging disposition to the final plugging disposition can be in the same direction. With such a configuration, the operation of the CPA leads to the lever being reliably moved to the final plugging disposition.

The CPA can be inserted into the lever such that, in the delivery position and in the ready-to-lock position, the CPA is accessible from outside the arrangement and can be moved from the delivery position through the ready-to-lock position to the locking position. The CPA can then be configured to be movable with the lever and at the same time relative to the lever.

In the locking position, the CPA can be in engagement with the housing in order to secure the lever in the final plugging disposition at the housing. The movement of the lever is then locked when the lever is disposed in the final plugging disposition and the CPA is disposed in the locking position. The lever can have a further securing device, for example in the form of a lever latch, which acts directly between the lever and the housing in the final plugging disposition and secures the lever in the final plugging disposition. The lever latch can be locked or blocked by the CPA that is disposed in the locking position when in the locked state. In one configuration of the arrangement, the CPA can only be moved from the ready-to-lock position to the locking position when the lever latch has engaged with the housing. If the lever latch is not engaged, the movement of the CPA from the ready-to-lock position to the locking position can be blocked, in particular by the lever latch itself.

In the final plugging position, the lever latch can be configured to latch in a self-active manner when the CPA is disposed in the ready-to-lock position. This means that the lever is secured in a self-active manner when it is moved to the final plugging disposition and the CPA is disposed in the ready-to-lock position.

The lever latch can comprise a latching device on the housing side and a correspondingly configured complementary latching device on the lever side, which, in the final plugging disposition, are in engagement with each other. In one configuration, the lever latch can be blocked by a CPA that is not disposed in the ready-to-lock position. In such a configuration, the lever latch can therefore only be operated when the CPA is disposed in the ready-to-lock position. For example, at least one of the latching devices of the lever latch can be blocked by the CPA that is not disposed in the ready-to-lock position, so that it cannot be made to engage with the other latching device of the lever latch.

In one configuration, the lever latch can be operated, in particular when the CPA is disposed in the delivery position, in order to secure the lever in the delivery state. Since the lever is not blocked by the CPA, the lever latch can be easily released manually, for example, by the preassembly technician or assembler, for moving the lever to a different disposition, for example, to the pre-plugging disposition.

In the delivery position and the ready-to-lock position, the CPA is preferably detached from the housing or not latched to the housing, respectively. In the delivery position and/or in the ready-to-lock position, the CPA therefore releases the lever for a movement from the final plugging disposition to the pre-plugging disposition and/or from the pre-plugging disposition to the final plugging disposition, which makes preassembling easier. In the delivery position, the CPA can be latched to the lever so that it cannot fall off during transport.

In one configuration, the lever can be secured at the housing in the final plugging disposition only when the CPA is disposed in the locking position. This ensures correct positioning, and incorrect assembly can be quickly identified.

The CPA can be configured to be latchable at the housing in the locking position or can be latched to the housing. The housing can comprise a latching device to which the CPA latches in the locking position. For example, the CPA can comprise at least one elastically deflectable element, such as a latch arm, which latches to the latching device of the housing.

In an advantageous configuration, the lever in the final plugging disposition can latch to the same latching device of the housing to which the CPA latches. The lever can comprise an element that can be made to engage with the housing, such as a latch hook, which is in engagement with the housing when in the plugged state.

The latching device of the housing can be configured as a projection, a latch hook, a stop surface, a groove, and/or a latching lug that affixes the lever in the final plugging disposition or that latches to the at least one elastically deflectable element of the CPA and/or the latching element of the lever.

In one configuration, the CPA can be moved from the ready-to-lock position to the locking position only when the lever is latched to the housing in the final plugging disposition, for example, by way of the lever latch.

The arrangement can comprise a first locking mechanism by which a movement of the CPA from the ready-to-lock position to the locking position is blocked. Such a locking mechanism prevents the CPA from being accidentally moved to the locking position, which could lead to an undefined state of the arrangement.

The arrangement can comprise a trigger which acts upon the first locking mechanism, in particular exclusively, in the final plugging disposition of the lever and releases the locking mechanism so that a movement of the CPA from the ready-to-lock position to the locking position is enabled. The trigger can be arranged at the housing or at the lever.

In one configuration, a latching element of the lever latch serves as a trigger for the first locking mechanism. In this way, for example, the first locking mechanism is released in a self-active manner only when the lever latch is engaged.

The first locking mechanism can comprise, for example, a latching device at the lever and a complementary latching device at the CPA. In the ready-to-lock position, the two latching devices of the first locking mechanism are latched to each other or the latching devices of the first locking mechanism are in engagement with each other. In the final plugging disposition of the lever, at least one of the two latching devices can be deflected by the trigger and the latching can thus be released. In particular, in the final plugging disposition of the lever, the latching devices of the first locking mechanism can be disengaged from one another by the trigger.

Instead of or in addition to the latching devices, the first locking mechanism, in a further configuration, can comprise a blocking element, by way of which a movement of the CPA from the ready-to-lock position to the locking position is blocked outside the final plugging disposition. Latching in the ready-to-lock position is not necessary in this configuration. Only the movement of the CPA from the ready-to-lock position to the locking position is blocked. The blocking element can also be a latching device of the first locking mechanism. In this configuration, the trigger in the final plugging disposition acts upon the blocking element and releases its blockage. The movement of the CPA from the ready-to-lock position to the locking position is enabled. This can be done, for example, by the blocking element being deflected by the trigger, preferably only in the final plugging disposition. In this configuration, the trigger can be triggered by part of the housing or of the lever and operated in a self-active manner once the lever is moved to the final plugging disposition and the CPA is disposed in the ready-to-lock position.

The blocking element prevents the CPA from accidentally slipping from the ready-to-lock position to the locking position.

In one configuration, the CPA must be moved manually to the locking position when the lever is disposed in the final plugging disposition to ensure correct plugging and to indicate complete final assembly. The blockage can be released by the blocking element by manual operation or a pressing action by an assembly person or an assembly person with tools.

The ready-to-lock position is preferably located between the delivery position and the locking position. In the locking position, the CPA is preferably moved further into the lever than in the delivery position. With this configuration, all positions of the CPA can be reached by a press-in action, starting from the delivery position, which makes handling easier.

In an advantageous configuration, the blocking element and the latching device of the lever latch are formed by the same element. The blocking element is therefore simultaneously the latching device or the latching element, respectively, for the CPA and the lever at the housing.

Preferably, the CPA can be moved to the ready-to-lock position only when the lever is in the pre-plugging disposition. Latching the lever in the final plugging disposition to the housing is preferably possible only when the CPA is disposed in the ready-to-lock position.

The arrangement can comprise a second locking mechanism independent of the first locking mechanism, by which a movement of the CPA from the delivery position to the ready-to-lock position is blocked, in particular outside the pre-plugging disposition.

For example, the CPA can be latched in the delivery state by the second locking mechanism. The second locking mechanism can comprise mutually complementary latching devices arranged at the lever and at the CPA. In the delivery state, the latching devices of the second locking mechanism are in engagement with one another.

The arrangement can comprise a release element which acts upon the second locking mechanism, in particular exclusively in the pre-plugging disposition, and releases it so that the CPA can be moved from the delivery position to the ready-to-lock position. The release element can be arranged, for example, at the housing. In particular, the release element is configured to disengage the latching devices of the second locking mechanism from one another in the pre-plugging disposition.

In a further configuration, the arrangement can comprise a driver which, when the lever is in the pre-plugging disposition, acts upon the CPA that is disposed in the delivery position and exerts a force upon it that is directed towards the ready-to-lock position. The driver can be disposed at the housing. The driver allows the CPA to be moved in a self-active manner from the delivery position to the ready-to-lock position when the lever is moved to the pre-plugging disposition.

The driver can be structurally combined with the release element. For example, the driver can be formed by a housing section, in particular a projection, onto which the CPA runs in the pre-plugging disposition. The force directed by the driver to the ready-to-lock position releases the second locking mechanism, for example, by deflecting a latching element of the second locking mechanism, and at the same time presses the CPA, which is thus unlocked, to the ready-to-lock position.

According to one configuration, one of the latching devices of the second locking mechanism can be a latching device on the lever side in the form of a locking element that is latched to the CPA in the delivery position. This latching can be maintained in particular when the lever is moved from the pre-plugging disposition to the final plugging disposition and/or from the final plugging disposition to the pre-plugging disposition. The locking element can in particular block the movement of the CPA from the delivery position directly to the locking position.

A second latching device of the second locking mechanism can be an elastically deflectable element on the side of the CPA, which, for example, in addition to a latch arm for latching to the housing, can also comprise a further latch arm for latching to the lever, a lever latch arm.

In one configuration, the second locking mechanism can comprise a stop surface against which, for example, the lever latch arm strikes or abuts in the delivery position. In a further embodiment, the second clamping mechanism can comprise a recess or groove. In the configuration with the groove, at least part of the CPA, in particular a latching device of the second clamping mechanism, for example, a latching lug of the lever latch arm, can be recessed in the groove so that a movement of the CPA in the direction of displacement, in particular to a different position, is prevented.

In order to move the CPA from the delivery position to the ready-to-lock position and thus release it, the elastically deflectable element of the CPA can be pressed or driven out of the groove.

In the configuration with the stop surface in the lever, the elastically deflectable element can be moved away from the stop surface and deflected. The stop surface can be disposed in particular inside the lever or the web, respectively, and project perpendicular to the direction of displacement of the CPA. If the CPA is now pushed further in the direction of displacement, i.e. further into the lever, for example, from the outside, then the elastically deflectable element, which is blocked by the stop surface, can be deflected by the force action such that the end of the elastically deflectable element disposed further in the interior of the lever along the direction of displacement, is deflected in the direction of the upwardly projecting stop surface until the elastically deflectable element of the CPA no longer abuts the stop surface. The entire CPA can then be pushed further in the direction of displacement. After deflection, the elastically deflectable element, for example, a latching lug of the latch arm, can snap back and can now be located behind the stop surface. After being released, the CPA is no longer locked in the direction of displacement by the locking element presently described by way of example as a stop surface.

The CPA can preferably be moved to the locking position only after the CPA has been moved from the delivery position to the ready-to-lock position.

In one configuration, the lever can be moved from the final plugging disposition to the pre-plugging disposition only when the CPA is disposed in the delivery position in order to enable further processing of the assembly after delivery. In a further configuration, the lever can be moved from the final plugging disposition to the pre-plugging disposition only when the CPA is disposed in the ready-to-lock position.

The CPA can be moved from the delivery position to the ready-to-lock position only when the lever is in the pre-plugging disposition. This can prevent accidental locking.

In order to enable the CPA to be latched to the housing only when the lever is in the final plugging disposition, the CPA can be moved from the ready-to-lock position to the locking position only when the lever is disposed in the final plugging disposition, for example, by way of the first locking mechanism mentioned above. In another configuration, the blocking element in the housing mentioned above prevents the CPA from slipping from the ready-to-lock position to the locking position when the lever is moved to the final plugging disposition. In particular, the arrangement can be configured such that only the CPA disposed in the ready-to-lock position can be moved to the locking position. This intermediate step increases safety and user-friendliness and can be an indicator of the readiness to lock. For example, the CPA can be moved from the delivery position to the ready-to-lock position after the preassembling process has been completed in order to minimize errors and ensure efficient assembly and further processing.

The housing can comprise a housing base and a housing cover. The release element and/or the driver can be arranged at the housing cover. The housing cover can be mounted on the housing base and in the pre-plugging disposition and/or in the final plugging disposition be arranged between the lever and the housing base. The housing cover can be arranged in particular between the web of the lever and the housing base.

For example, the contact elements are arranged in the housing base, while the housing cover leads one or more cables out of the housing, in particular from the side.

The release element and/or the driver can be disposed at the housing cover. With this configuration, it is not possible to move the CPA from the delivery position to another position as long as the housing cover is not mounted. In the delivery state of the arrangement, for example, the housing cover is not yet mounted on the housing base, but in the ready state it is.

In one configuration of the connector assembly, the lever can be in the pre-plugging disposition and the CPA in the locking position prior to final assembly. After final assembly, the lever can be disposed in the final plugging disposition and the CPA in the locking position. The arrangement is then firmly connected to the mating connector.

In the following, the invention shall be described by way of example using embodiments with reference to the drawings. In the drawings, the same reference characters are always used for elements which correspond to one another with regard to function and/or structure.

### BRIEF DESCRIPTION OF THE DRAWINGS

In accordance with the above description, a feature of the embodiment can be omitted if the technical effect associated with this feature is not important for a specific application. Conversely, a feature that is not yet present there can also be added to the embodiment in accordance with the above description if the technical effect of the feature to be added is important for a specific application.

FIG. 1 shows a schematic illustration of a configuration of the arrangement in the final plugging disposition;

FIG. 2 shows a schematic illustration of a configuration of the arrangement in the final plugging disposition and the delivery position;

FIG. 3 shows a schematic illustration of a configuration of the arrangement in the pre-plugging disposition and the ready-to-lock position;

FIG. 4 shows a schematic illustration of a configuration of the arrangement in the final plugging disposition and the locking position;

FIG. 5 shows a schematic sectional view of a configuration of the arrangement in the final plugging disposition and the delivery position;

FIG. 6 shows a schematic sectional view of a configuration of the arrangement in the final plugging disposition and the ready-to-lock position;

FIG. 7 shows a schematic sectional view of a configuration of the arrangement in the final plugging disposition and the ready-to-lock position;

FIG. 8 shows a schematic side view of a configuration of the connector assembly in the pre-plugging disposition and the delivery position;

FIG. 9 shows a schematic side view of a configuration of the plugging assembly in the pre-plugging disposition and the ready-to-lock position.

FIG. 10 shows a schematic illustration of a configuration of the connector assembly with the arrangement and a mating connector; and

FIG. 11 shows a schematic illustration of a configuration of the connector assembly in the assembled state.

### DETAILED DESCRIPTION OF THE INVENTION

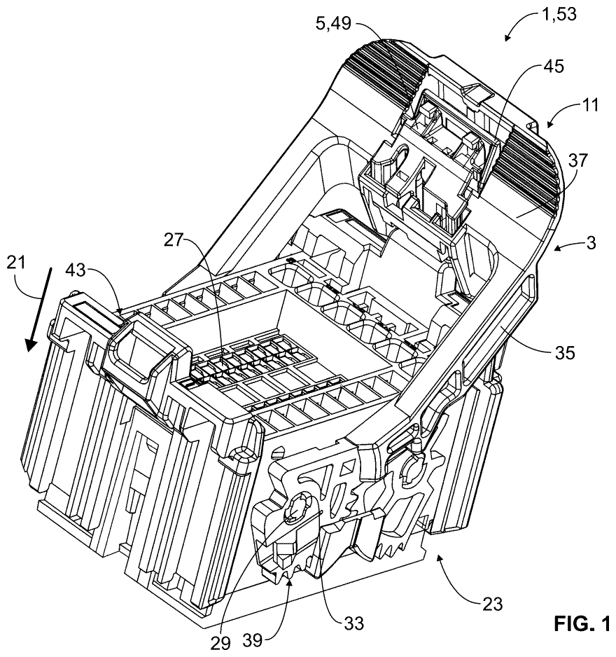

FIGS. 1 to 9 each illustrate an arrangement 1 for an electrical connector. Arrangement 1 comprises a lever 3 and a CPA 5 attached to lever 3. CPA 5 can assume different positions relative to lever 3 and lever 3 can assume different dispositions. The positions of CPA 5 are linked to the different dispositions of lever 3.

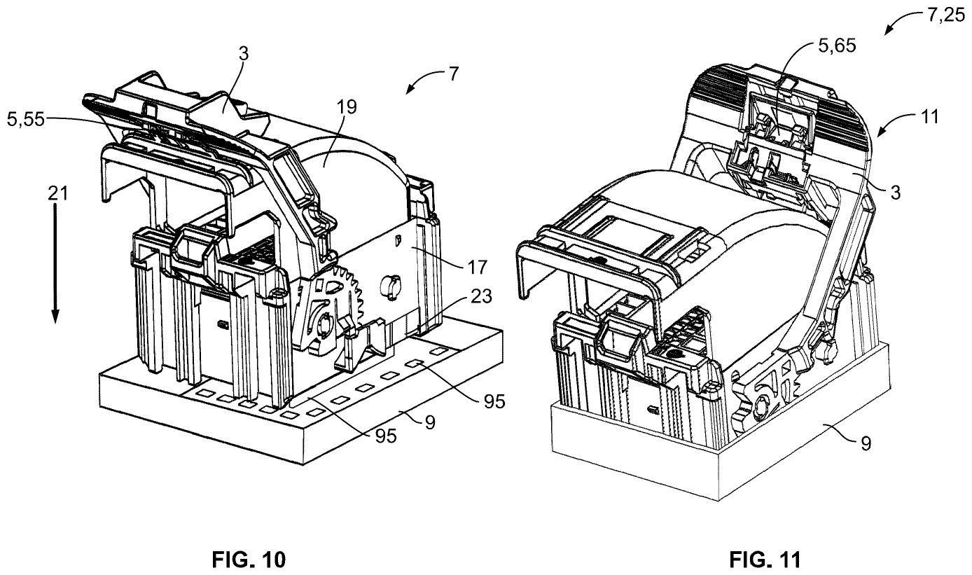

FIGS. 10 and 11 show a connector assembly 7 with an embodiment of arrangement 1 and a mating connector 9 that can be plugged together therewith.

In FIGS. 1, 2, 4 and FIGS. 5 to 7, arrangement 1 is shown with lever 3 disposed in a final plugging disposition 11, where CPA 5 assumes different positions in each case. FIGS. 3, 9 and 10 show arrangement 1 with lever 3 in a pre-plugging disposition 13 with CPA 5 in different positions in each case.

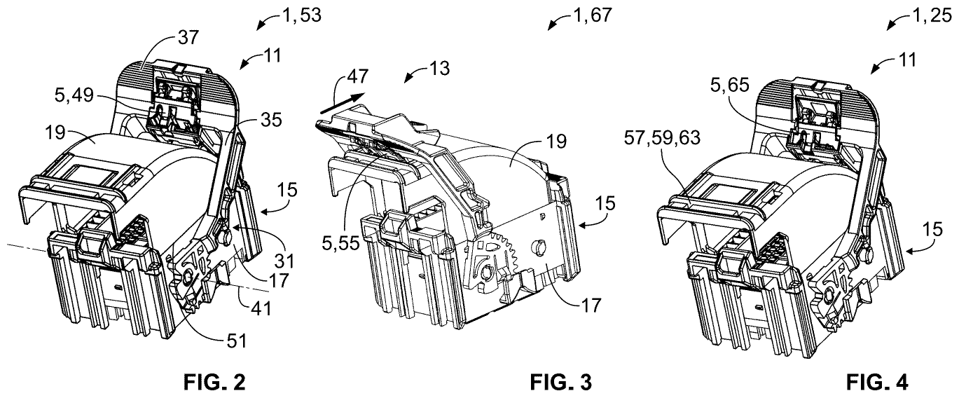

In addition to lever 3 and CPA 5, arrangement 1 comprises a housing 15 to which lever 3 is attached. As shown in FIG. 1, housing 15 comprises a housing base 17 on which a housing cover 19 (FIG. 2) can be mounted. Housing base 17 can be configured to receive contacts, terminals and/or electrical conductors (not shown) and in particular to be connected to the contacts or terminals inserted in housing base 17 in plugging direction 21 with mating connector 9 (FIG. 10) or contacts or terminals of mating connector 9. Lever 3 can serve as a plugging aid for transmitting and generating a uniform plugging force during the plugging process. Lever 3 advantageously draws mating connector 9 in a direction opposite to plugging direction 21 towards arrangement 1 forming a connector 23. For this purpose, lever 3 can be pivoted about housing 15.

Lever 3 of arrangement 1 can in particular be moved from pre-plugging disposition 13 to final plugging disposition 11. In pre-plugging disposition 13 of lever 3, arrangement 1 is configured to be pluggable to a mating connector 9. In final plugging disposition 11 of lever 3, lever 3 is locked to housing 15 and arrangement 1 is in an assembled state 25 in which connector 13 of arrangement 1 is fully assembled with mating connector 9. Pre-plugging disposition 13 of lever 3 is different from final plugging disposition 11 of lever 3. In pre-plugging disposition 13, lever 3 is rotated or pivoted relative to final plugging disposition 11 towards housing 15.

The complete assembly or assembled state 25 means that mating connector 9 and connector 23 are fully and correctly plugged together and enable the transmission of electrical current. Assembled state 25 is evident in FIG. 11 and described in more detail below.

Housing base 17 can be formed to be cuboid-shaped and provided with contact receptacles 27 into which contacts or terminals can be inserted. Housing base 17 can have round protrusions 29 on two oppositely disposed sides 31 in the form of, for example, axle stubs that protrude from sides 31 of housing base 17.

Lever 3 can be pivotally connected to housing 15 via round protrusions 29. For this purpose, protrusions 29 can each be inserted into recesses 33 provided for this purpose. A protrusion 29 and recess 33 that is complementary thereto each form a sliding bearing.

In the configuration shown, lever 3 is configured such that it comprises two legs 35 that run parallel to one another and are connected by way of a web 37. Recesses 33 can each be arranged on end 39 of legs 35 pointing towards mating connector 9 in order to mount lever 3 at housing 15. In other words, lever 3 can be configured to be U-shaped, where housing 15 can be arranged between legs 35 and web 37.

An axis of rotation 41, about which the lever can be pivoted, runs axially through protrusions 29. Axis of rotation 41 runs in particular perpendicular to plugging direction 21. Lever 3, in particular its web 37, is preferably disposed on side 43 of arrangement 1 facing away from mating connector 9.

CPA 5 can preferably be inserted into lever 3. Lever 3 can comprise a receptacle 45 provided for this purpose, in particular in web 37.

CPA 5 is received in receptacle 45 to be movable along a direction 47 of displacement. Direction 47 of displacement is directed into lever 3 and points in the same direction as the movement of lever 3 from pre-plugging disposition 13 to final plugging disposition 11. CPA 5 can be disposed on the side of the lever or web 37 facing housing 15.

In FIG. 1 and FIG. 2, arrangement 1 is shown with lever 3 disposed in final plugging disposition 11 and CPA 5 disposed in delivery position 49.

Both figures show a delivery state 55 of arrangement 1. In this state, arrangement 1 is delivered, for example, to a preassembly technician or assembler who inserts contacts into housing 15 and/or attaches arrangement 1 to a cable harness.

In delivery position 49 of CPA 5, lever 3 is freely movable from final plugging disposition 11, for example, to pre-plugging disposition 13 (FIG. 3). The movement of lever 3 is not locked or blocked by the CPA when CPA 5 is in delivery position 49.

In delivery state 55, housing cover 19 does not need to be mounted yet, as shown in FIG. 1, and can be added later.

In the assembled state, housing cover 19 can be arranged between housing base 17 and lever 3, preferably between two legs 35 and between web 37 and housing base 17. Edges 51 of housing cover 19 can then rest on edges of housing base 17.

FIG. 3 shows a configuration of arrangement 1 with lever 3 in pre-plugging disposition 13. In this illustration, CPA 5 is in ready-to-lock position 55. A movement of lever 3 from final plugging disposition 11 to pre-plugging disposition 13 can equally take place when CPA 5 is disposed in ready-to-lock position 55.

Moving CPA 5 from delivery position 49 to ready-to-lock position 55 preferably takes place in a self-active manner when lever 3 is moved from final plugging disposition 11 (FIG. 2) to pre-plugging disposition 13 (FIG. 3). Housing 15, in particular housing cover 19, can comprise a release element 57 or a driver 59 for this purpose. In this configuration, driver 59 and release element 57 are structurally combined and formed by a single common element. Release element 57 and/or driver 59 can be configured as a release edge 63 at housing cover 19 which projects from housing cover 19 towards the lever. When lever 3 is moved to pre-plugging disposition 13, CPA 5 is preferably pressed against release edge 63 and pushed into lever 3 in direction 47 of displacement by this release edge 63.

In ready-to-lock position 55 of CPA 5 shown in FIG. 3, the movement of CPA 5 to locking position 65 is enabled. For example, after the preassembling process, housing cover 19 can be mounted to housing base 17 to indicate that arrangement 1 is ready for assembly, i.e. is in a ready state 67. In ready state 67, lever 3 is disposed in pre-plugging disposition 13 as shown and CPA 5 is disposed in ready-to-lock position 55.

If lever 3 is now moved from pre-plugging disposition 13 to final plugging disposition 11 after CPA 5 has been moved to ready-to-lock position 55, then CPA 5 can be moved from ready-to-lock position 55 along direction 47 of displacement to locking position 65. In locking position 65, lever 3 is additionally secured to housing 15 by CPA 5, a movement of lever 3 is blocked, and arrangement 1 is disposed in an assembled state 25, as illustrated in FIGS. 4 and 11. In particular, displacement of CPA 5 to locking position 65 can take place only if lever 3 is already latched to housing 15. If lever 3 and housing 15 are not latched to one another, then CPA 5 can be blocked from being moved to locking position 65. For example, this can be done by a blocking element or a first locking mechanism 66 which latches CPA 5 to lever 3 or a latching device of lever 3.

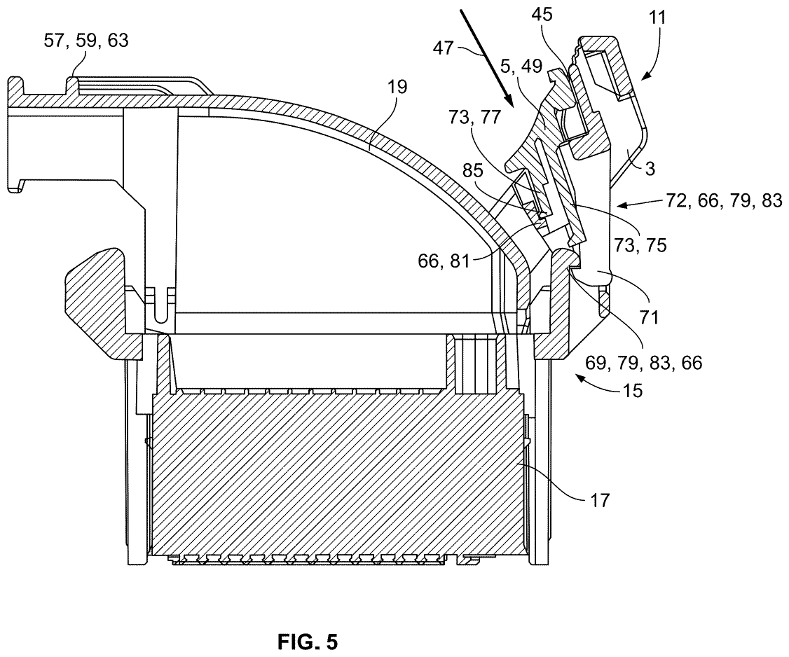

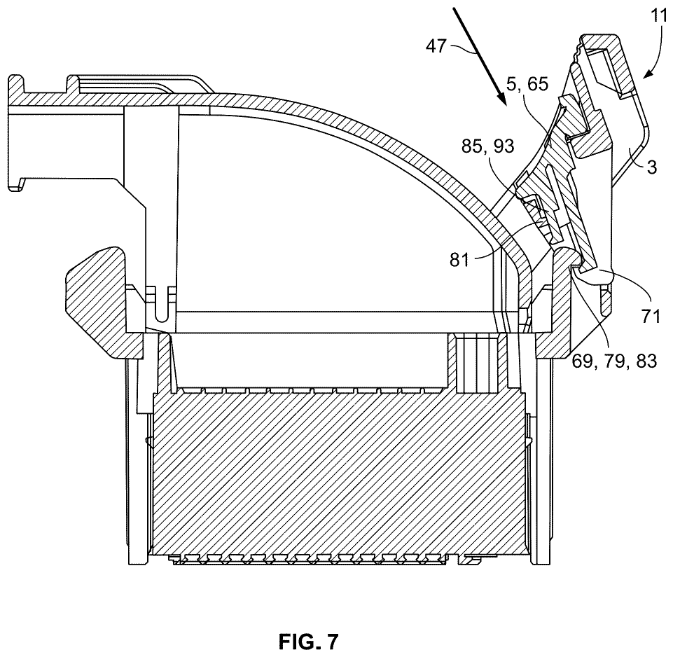

FIGS. 5 to 7 each show a sectional view of arrangement 1. The illustrations mentioned show by way of example how locking of CPA 5, for example, a second locking mechanism 68, in delivery position 49 can be implemented. FIG. 7 shows by way of example how latching of CPA 5 to housing 15 can be implemented and lever 3 can be latched to a latching device 69 of housing 15.

In FIG. 5, lever 3 is illustrated in final plugging disposition 11 in which a latching element, for example, a latch hook 71 of lever 3, can be latched to latching device 69 of housing 15. This lever latch 72 secures lever 3 to housing 15. In this illustration, CPA 5 is in delivery position 49 and arrangement 1 is therefore in delivery state

### 55.

CPA 5 can comprise two elastically deflectable elements, for example, latch arms 73. One latch arm 73, for example, a housing latch arm 75, which can be latched to housing 15, can be configured to be longer in direction 47 of displacement than other latch arm 73, for example, a lever latch arm 77, which can be latched to the lever. Longer latch arm 73, such as housing latch arm 75, can be spaced from latching device 69 of housing 15 in delivery position 49 and can be released from housing 15, i.e. CPA 5 is not connected or latched to housing 15. A movement of lever 3 about axis of rotation 41 is therefore not blocked by CPA 5. The latching of latch hook 71 of lever 3 to latching device 69 of housing 15 only has to be released in order to enable a movement of lever 3.

Shorter lever latch arm 77 can abut a locking element 81, for example, a stop surface of lever 3 which blocks a movement of CPA 5 in direction 47 of displacement.

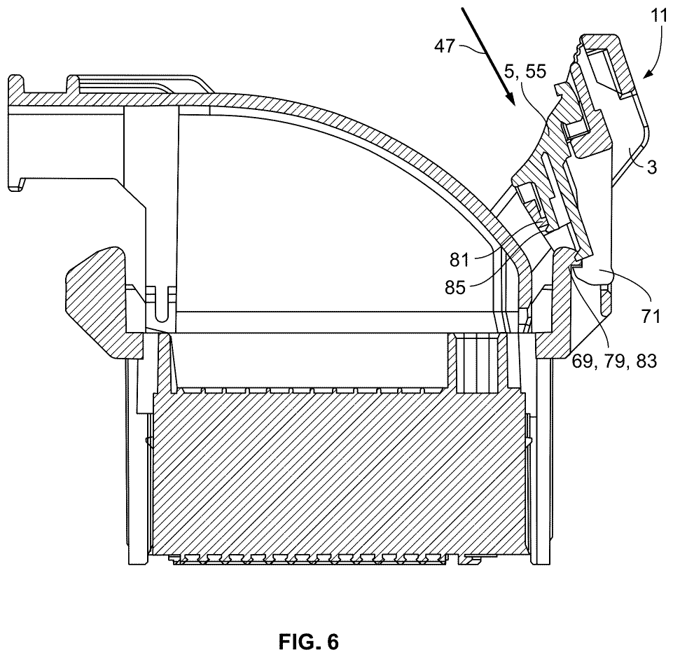

In FIG. 6, a configuration of arrangement 1 is shown with a lever 3 in final plugging disposition 11 and a CPA 5 in the ready-to-lock position 55.

In ready-to-lock position 55, CPA 5 is not latched to housing 15. In particular, housing latch arm 75 of CPA 5 cannot be latched to latching device 69 of housing 15. Shorter lever latch arm 77 can no longer abut stop surface 81 of lever 3 in ready-to-lock position 55. This enables a movement of CPA 5 to be enabled in direction 47 of displacement and CPA 5 can be brought into locking position 65 in direction 47 of displacement.

A blocking element 79 can be used to block CPA 5 from accidentally slipping from ready-to-lock position 55 to locking position 65, in particular outside final plugging disposition 11 of lever 3. When lever 3 is disposed in final plugging disposition 11, blocking of CPA 5 by blocking element 79 can be released. A movement of CPA 5 from ready-to-lock position 55 to locking position 65 is then possible. CPA 5 must therefore be brought or pressed to locking position 65, for example, by applying force, in order to secure lever 3.

Blocking element 79 and latching device 69 can be formed by the same element 83 in an advantageous configuration.

Locking position 65 of CPA 5 is illustrated in FIG. 7. Lever 3 is in engagement with housing 15 and therefore in final plugging disposition 11. Housing latch arm 75 of CPA 5 latches to latching device 69 of housing 15 and additionally secures lever 3 to housing 15 so that a movement of lever 3 about axis of rotation 41 is blocked and lever 3 in particular cannot be released or moved unintentionally. In locking position 65, CPA 5 can be completely inserted or sunk into lever 3 in direction 47 of displacement. In this case, arrangement 1 is disposed in assembled state 25.

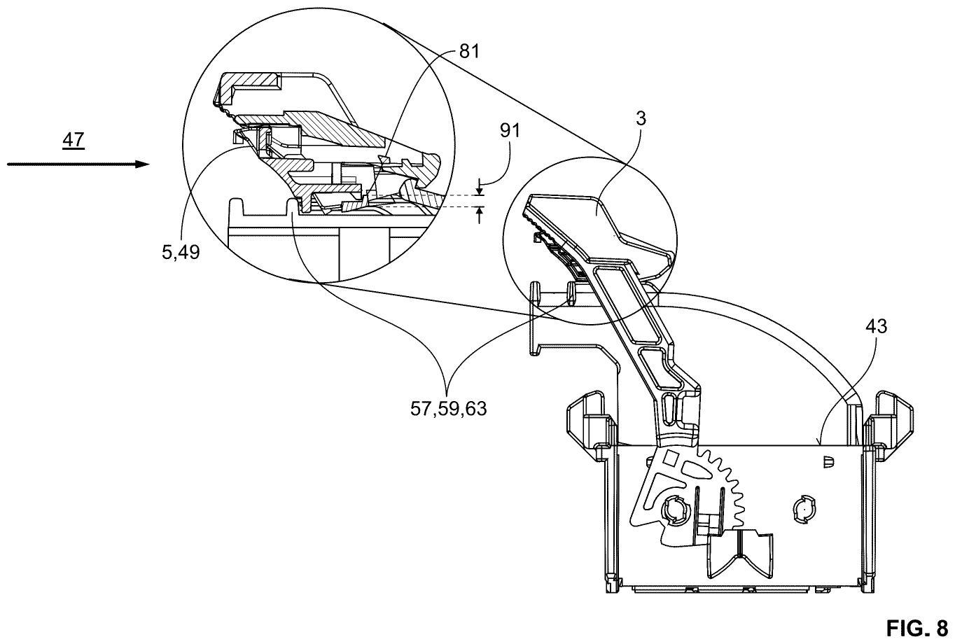

Release edge 63 of housing cover 19 can be used for moving CPA 5 from delivery position 49 to ready-to-lock position 55. FIG. 8 illustrates a configuration of arrangement 1 with lever 3 moving to pre-plugging disposition 13. In this case, CPA 5 is in delivery position 49, i.e. lever latch arm 77 of CPA 5 abuts stop surface 81 of lever 3. In this illustration, lever 3 has not yet been fully moved to pre-plugging disposition 13.

The movement of lever 3 to pre-plugging disposition 13 can press CPA 5 in direction 47 of displacement into lever 3, as lever 3 is moved towards release edge 63 and release edge 63 thereby comes into contact with CPA 5. As a result of the force exerted by release edge 63 upon CPA 5 abutting stop surface 81, lever latch arm 77 of CPA 5 is elastically deflected away from housing 15 so that lever latch arm 77, in particular lever latch lug 85, is at least briefly pressed away from stop surface 81 of housing 15 against direction 21 of insertion of arrangement 1 such that height 91 of stop surface 81 is overcome, so that lever latch arm 77 and therefore entire CPA 5 can be moved onward in direction 47 of displacement. Lever latch arm 77 thereafter moves or snaps back to its original position 93. A movement of CPA 5 in direction 47 of displacement is now enabled.

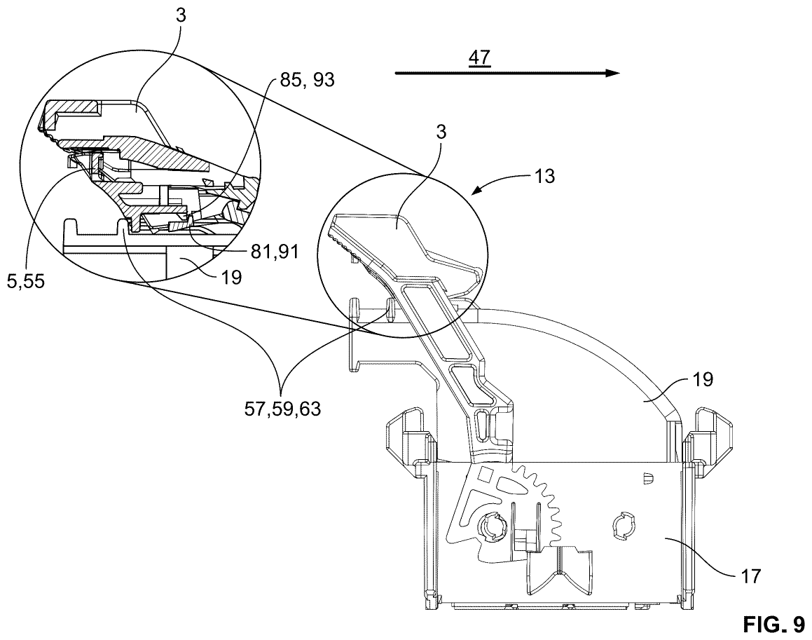

In FIG. 9, lever 3 is disposed completely in pre-plugging disposition 13 and CPA 5 is disposed in ready-to-lock position 55 and is now sunk further into lever 3 in direction 47 of displacement. In this illustration, stop surface 81 no longer obstructs CPA 5. Lever latch lug 85 of CPA 5 can be spaced further from stop surface 81 in direction 47 of displacement.

In FIG. 10, a connector assembly 7 is illustrated which has a configuration of arrangement 1 with a lever 3 in pre-plugging disposition 13. Arrangement 1 is shown there in ready state 67, i.e. CPA 5 is in ready-to-lock position 55. Lever 3 can be disposed in pre-plugging disposition 11.

Mating connector 9 comprises contacts 95, to which arrangement 1 can be connected. Arrangement 1 is therefore configured to be pluggable with mating connector 9.

Fully assembled connector assembly 7 is shown in FIG. 11. In other words, contacts 95 are connected to one another and CPA 5 secures lever 3, e.g. by latching to housing 15. Mating connector 9 and connector 23 are fully plugged together and arrangement 1, as well as entire connector assembly 7, are in assembled state 25. Lever 3 can only be released after the lock has been released by CPA 5. CPA 5 additionally secures lever 3 to housing 15 and a movement of lever 3 away from final plugging disposition 11 is blocked.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Arrangement for an electrical connector that can be plugged together with a mating connector comprising:
a housing;
a lever attached to the housing, the lever being movable between a pre-plugging disposition and a final plugging disposition; and
a connector position assurance device (CPA) movably attached to the lever, the CPA being movable from a delivery position through a ready-to-lock position to a locking position;
wherein the CPA secures the lever in the final plugging disposition to the housing when in the locking position;
wherein the lever is movable from the final plugging disposition to the pre-plugging disposition when the CPA is disposed in the delivery position;
wherein the CPA is movable from the delivery position to the ready-to-lock position when the lever is in the pre-plugging disposition;
wherein the lever is movable to the final plugging disposition when the CPA is in the ready-to-lock position; and
wherein the CPA is movable to the locking position when the lever is in the final plugging disposition and when the CPA is in the ready-to-lock position.

2. Arrangement according to claim 1, wherein the lever is secured at the housing in the final plugging disposition only when the CPA is disposed in the locking position.

3. Arrangement according to claim 1, wherein the lever is movable from the final plugging disposition to the pre-plugging disposition only when the CPA is disposed in either the delivery position or in the ready-to-lock position.

4. Arrangement according to claim 1, wherein the CPA is movable from the delivery position to the ready-to-lock position only when the lever is in the pre-plugging disposition.

5. Arrangement according to claim 1, wherein the CPA is movable from the ready-to-lock position to the locking position only when the lever is disposed in the final plugging disposition.

6. Arrangement according to claim 1, wherein only the CPA disposed in the ready-to-lock position is movable to the locking position.

7. Arrangement according to claim 1, wherein the lever comprises a locking element which locks the CPA in the delivery position.

8. Arrangement according to claim 7, wherein
a release element and a driver are arranged at the housing;
wherein the release element is configured to release the lock of the CPA by the locking element in the lever, and
wherein the driver is configured to drive a movement of the CPA from the delivery position to the ready-to-lock position when the lever is moved from the final plugging disposition to the pre-plugging disposition.

9. Arrangement according to claim 8, wherein the release element and the driver are formed by the same element.

10. Arrangement according to claim 8, wherein the housing comprises a housing base and a housing cover;
wherein the housing cover is mounted on the housing base with the release element for moving the CPA from the delivery position to the ready-to-lock position, and
wherein the housing cover is arranged in the pre-plugging disposition and in the final plugging disposition between the lever and the housing base.

11. Arrangement according to claim 1, wherein the housing comprises a latching device to which the CPA latches in the locking position.

12. Arrangement according to claim 1, wherein the housing comprises a blocking element by way of which a movement of the CPA from the ready-to-lock position to the locking position is blocked outside the final plugging disposition.

13. Arrangement according to claim 12, wherein the blocking element is formed by the latching device.

14. Arrangement according to claim 1, wherein the lever comprises two parallel legs and a web connecting the two legs to one another,
wherein the CPA is arranged at the web.

15. Connector assembly comprising
a mating connector; and
an arrangement for an electrical connector that can be plugged together with the mating connector, the arrangement comprising:
a housing;
a lever attached to the housing, the lever being movable between a pre-plugging disposition and a final plugging disposition; and
a connector position assurance device (CPA) movably attached to the lever, the CPA being movable from a delivery position through a ready-to-lock position to a locking position;
wherein the CPA secures the lever in the final plugging disposition to the housing when in the locking position;
wherein the lever is movable from the final plugging disposition to the pre-plugging disposition when the CPA is disposed in the delivery position;
wherein the CPA is movable from the delivery position to the ready-to-lock position when the lever is in the pre-plugging disposition;
wherein the lever is movable to the final plugging disposition when the CPA is in the ready-to-lock position;
wherein the CPA is movable to the locking position when the lever is in the final plugging disposition and when the CPA is in the ready-to-lock position; and
wherein the connector and the mating connector can be plugged together in the pre-plugging disposition of the lever and the connector and the mating connector are completely assembled in the final plugging disposition of the lever.
